(19) United States
(12) Patent Application Publication
(10) Pub. No.: US 2023/0131178 A1
(43) Pub. Date: Apr. 27, 2023

(54) WATER CIRCULATION INTELLIGENT SENSING AND MONITORING SYSTEM BASED ON DIFFERENTIABLE REASONING

(71) Applicant: TIANJIN UNIVERSITY, Tianjin (CN)

(72) Inventors: Li HE, Tianjin (CN); Yuxuan WANG, Tianjin (CN)

(73) Assignee: TIANJIN UNIVERSITY, Tianjin (CN)

(21) Appl. No.: 17/901,119

(22) Filed: Sep. 1, 2022

(30) Foreign Application Priority Data
Oct. 25, 2021 (CN) CN202111243146.5

(51) Int. Cl. G06N 5/02; G06N 5/04; C02F 1/00

(52) U.S. Cl. CPC G06N 5/022; G06N 5/04; C02F 1/00

(57) ABSTRACT

Disclosed is a water circulation intelligent sensing and monitoring system based on differentiable reasoning, including a processor module, wherein a data terminal of the processor module is connected to a feature knowledge base module, an intelligent sensing module and an intelligent control module, respectively; the intelligent sensing module is connected to the feature knowledge base module through a conversion module; the feature knowledge base module includes a differentiable reasoning unit, a feature knowledge base unit and a feature knowledge graph unit; and a data terminal of the feature knowledge graph unit is connected to the differentiable reasoning unit, the feature knowledge base unit and the conversion module. The system aims to solve the technical problems of low precision, low efficiency, long time consumption and complicated operation in an existing water environment monitoring and control method, and provides a water circulation intelligent sensing and monitoring system based on differentiable reasoning.

### CROSS-REFERENCE TO RELATED APPLICATIONS

This application claims priority to Chinese Application No. 202111243146.5, having a filing date of Oct. 25, 2021, the entire contents of which are hereby incorporated by reference.

### FIELD

The present invention belongs to the technical field of water environment monitoring and restoration, and particularly relates to a water circulation intelligent sensing and monitoring system based on differentiable reasoning.

### BACKGROUND

With the development of economy and the adjustment of industrial structure, water environment pollution events occur frequently. According to the statistics of the Ministry of Supervision, the current water resources have been seriously polluted and continuously deteriorated, with more than 1700 cases every year. According to the data of continuously monitoring 118 cities by related Departments in China, about 64% of urban groundwater is seriously polluted, and 33% of underground water is lightly polluted. At present, the water environment pollution control has become the most import thing. However, the current water environment monitoring and control method cannot accurately evaluate and analyze the water environment problems and match solutions at the first time, is complicated to operate and low in efficiency, requires a lot of manpower, and is far from meeting the water environment monitoring and restoration requirements. Therefore, the applicant proposed a water circulation intelligent sensing and monitoring system based on differentiable reasoning.

### SUMMARY

The present invention aims to solve the technical problems of low precision, low efficiency, long time consumption and complicated operation in an existing water environment monitoring and control method, and provides a water circulation intelligent sensing and monitoring system based on differentiable reasoning.

A water circulation intelligent sensing and monitoring system based on differentiable reasoning includes a processor module, wherein a data terminal of the processor module is connected to a feature knowledge base module, an intelligent sensing module and an intelligent control module respectively; the intelligent sensing module is connected to the feature knowledge base module through a conversion module;

the intelligent control module is configured to treat a water body that does not comply with a standard, thereby making the water environment comply with the standard;

the feature knowledge base module includes a differentiable reasoning unit, a feature knowledge base unit and a feature knowledge graph unit; and a data terminal of the feature knowledge graph unit is connected to the differentiable reasoning unit, the feature knowledge base unit and the conversion module.

The feature knowledge base unit includes a collection unit, a construction unit and an application unit;

the collection unit collects multi-source heterogeneous data;

the construction unit performs category classification, extraction and feature definition on the collected multi-source heterogeneous data to form a multi-category feature set, then performs heterogeneous knowledge fusion on the multi-source multi-category feature set and acquires a fusion feature by supervised random walk, and finally performs iterative reasoning on complicated problems according to the fusion feature and by differentiable reasoning, constructs a water circulation intelligent sensing and monitoring feature knowledge graph and stores the water circulation intelligent sensing and monitoring feature knowledge graph in the feature knowledge base; and

the application unit is linked with the intelligent sensing module and the intelligent control module by the differentiable reasoning unit, and performs water environment monitoring diagnosis, early warning or decision-making control services to realize cyclic control, optimization and updating.

When the differentiable reasoning unit is configured to update the feature knowledge graph unit and handle the complicated problems of the application unit, the following steps are adopted:

S₁: converting a received problem q (such as data index classification, warning information and decision-making schemes) into a distributed vector through input terminal preprocessing to obtain a context character string (cw₁, cw₂, . . . , cwₘ), wherein (h, r₁, r₂, . . . , rₘ₋₂,t) is used to express a fact triple and the problem is represented as qᵢ=| [symbol] ₁, [symbol] _{M}|, the context character string is linearly transformed into a position awareness vector qᵢ(i=1, 2, . . . , n), and qᵢ∈R^{q} is used to reflect a related problem of the i^{th} reasoning step,

wherein q refers to the received problem, m refers to the length of the character string, (cw₁, cw₂, . . . , cwₘ) refers to the context character string, the problem q may be expressed as q=| [symbol] ₁, [symbol] _{M}|, qᵢ(i=1, 2, . . . , n) represents a problem position awareness vector, the definitions of (h, r₁, r₂, . . . , rₘ₋₂,t) are referenced to the description of the embodiments of the present invention, h represents a head entity, r₁, r₂, . . . , rₘ₋₂ represent several relationships/attributes, t represents a tail entity/attribute value, qᵢ∈R^{q} is used to represent a set of the problem position awareness vectors, and the representation mode is a well-known expression mode in the art;

S₂: transmitting a reasoning task in the first step to a differentiable recurrent neural network, beginning to perform iterative reasoning for many times, wherein the differentiable recurrent neural network is composed of n differentiable recurrent neurons, each differentiable recurrent neuron participates in a current reasoning task, and each part is composed of a controller, an identification element and a memory element; for a reasoning process in the i^{th} step (i=1, 2, . . . , n), receiving a reasoning task awareness vector qᵢ in the i^{th} step and a memory vector mᵢ₋₁ obtained in a memory element in the (i−1)^{th} step, processing by the controller to obtain a control vector cᵢ=(qᵢ, mᵢ₋₁) and transferring the control vector to the identification element, associating global or local knowledge graph path planning with a current reasoning task control vector cᵢ by the identification element based on a given knowledge base, walking in the knowledge graph (KG) based on category feature of cᵢ to extract a representative path L(l₁, l₂ . . . lₗ), inferring and identifying a matched value P of the control vector cᵢ and the representative path L by a content similarity evaluation function and performing sorting to select an optimal path to obtain a solution vector Aᵢ=(cᵢ, pₘₐₓ), integrating cᵢ, mᵢ₋₁ and Aᵢ by the memory element, storing an integrated value into the memory mᵢ=(cᵢ, mᵢ₋₁, Aᵢ) and transferring to a next reasoning task cᵢ₊₁, iteratively performing the previous steps to obtain an iterative calculation answer through n steps of reasoning processes, wherein a storage structure is arranged in the memory element; storing an intermediate state in the reasoning process into a memory gate, inserting the intermediate state into mᵢ₋₁ and the to-be-generated mᵢ in the subsequent reasoning process, determining the similarity with the previous reasoning task, and if the similarity is high, skipping the reasoning step, directly calling the stored memory state, dynamically adjusting the length of the reasoning process and reducing the reasoning times,

wherein pₘₐₓ refers to the optimal path; and

S₃: outputting a final answer by an output terminal according to the problem q and the memory result mₙ in the final reasoning process.

A data terminal of the differentiable reasoning unit is bidirectionally linked with the feature knowledge base unit, the intelligent sensing module and the intelligent control module respectively in pairs; an output terminal of the intelligent sensing module is connected to an input terminal of the feature knowledge base unit; an output terminal of the intelligent control module is connected to the input terminal of the feature knowledge base unit; and the intelligent sensing module and the intelligent control module are bidirectionally linked.

The intelligent sensing module includes a target detection unit, a multi-sensor fusion unit, a multi-machine communication unit and an early warning unit; input terminals of the target detection unit and the multi-sensor fusion unit are configured to be connected to a monitoring robot, and output terminals of the target detection unit and the multi-sensor fusion unit are connected to an input terminal of the multi-machine communication unit; and an output terminal of the multi-machine communication unit is connected to an output terminal of the early warning unit.

The target detection unit gives instructions such as monitoring a parameter, monitoring a range and acquiring a period to the monitoring robot through a PC terminal or a mobile terminal, so that the monitoring robot performs intelligent sensing on the surrounding environment based on a millimeter wave radar, a laser radar and visible light and infrared modules, so as to acquire environment parameters of specified positions in real time; and for the heterogeneous multi-source characteristics of the acquired information, multiple-sensor information is fused to improve the environment sensing accuracy and robustness; a real-time monitoring state, environment sensing information, track key position video monitoring information and other data are sent back to an operating terminal by the multi-machine communication unit in real time; and real-time data is processed by the early warning unit.

When the water environment of the monitoring position is diagnosed by the intelligent sensing module, the following steps are adopted:

firstly, standardizing and normalizing a kinds of environment parameter monitoring data {a₁}, {a₂}, . . . , {aⱼ}, . . . {aₐ} in the acquisition period at a monitoring point to obtain aₕⱼ′, and using weighting average and processing each environment parameter to obtain aⱼ′; secondly, linking with differentiable reasoning to obtain geographic information of a monitoring position, and considering subjective and objective factors and performing reasoning to obtain a weight value Wᵥⱼ of each index; finally, constructing a parameter threshold model Vₐ by using each index value and weight value, in addition, performing reasoning in the knowledge base by differentiable reasoning to output a water environment evaluation threshold, establishing a grade evaluation set V_{f}′ (wherein f is a corresponding grade), performing normalization and standardization to obtain a combined threshold evaluation value V_{f}, connecting an output value of the parameter threshold model with the combined threshold evaluation value, and diagnosing the water environment state of the monitoring position, wherein related formulas are as follows:

$$\{ \begin{matrix}{a}_{hj}^{′} = \vert \frac{max \{ {a}_{h j} \} - {a}_{h j}}{max \{ {a}_{h j} \} - min \{ {a}_{h j} \}} \vert , h ∈ ( 0 , H ) \\ {a}_{j}^{′} = \frac{{Σ}_{j = 1}^{H} {a}_{hj}^{′}}{H} \\ {W}_{v} = \{ {W}_{v 1} , {W}_{v 2} , … , {W}_{v j} , … , {W}_{v a} \} , {W}_{v j} ∈ ( 0 , 1 ) \\ {V}_{a} = \frac{{Σ}_{j = 1}^{a} {W}_{ν j} {a}_{j}^{′}}{a} \\ \begin{matrix}{V}_{f} = \{ {V}_{1} , {V}_{2} , {V}_{3} , {V}_{4} , {V}_{5} \} = \\ \{ excellent , very good , good , poor , very poor \}\end{matrix}\end{matrix} ,$$

f is a grade value,

wherein aₕⱼ′ refers to an index value after the h^{th} sample of the j^{th} parameter is treated, aⱼ′ refers to an index value of the j^{th} parameter, and j and h refers to variables in the common sense in the art.

The intelligent control module includes a decision-making regulation and control unit, and an instruction generation and push unit connected to an output terminal of the decision-making regulation and control unit; an output terminal of the instruction generation and push unit is connected to an input terminal of a D/A converter; an output terminal of the D/A converter is connected to an input terminal of a function control unit; and the function control unit is configured to implement a control scheme, including dosing control and aeration control.

After the monitoring demonstrates that the water body complies with the standard in the early warning unit in the intelligent sensing module, the standard-complying information is updated to the feature knowledge base unit through the conversion module; if the monitoring demonstrates that the water body does not comply with the standard, an emergency warning unit sends a warning signal timely, and the decision-making regulation and control unit performs efficient simulation reasoning exercise on a complicated actual water body environment through the differentiable reasoning unit in the feature knowledge base module through the processor module according to the warning information, performs iterative solution and continuously adjusts an existing strategy to match and generate a high-quality verifiable control scheme as an alternative, and screens an optimal control scheme according to different types of multi-attribute decision-makings to solve the problems.

The specific steps are as follows:

taking, by the decision-making regulation and control unit, to-be-solved problems as input variables X based on the complicated actual water body environment according to the warning information, wherein the problems should specifically include time-space information of monitoring points, over-standard parameters and over-standard index values; performing differentiable reasoning iterative calculation to match in the feature knowledge base and generate k control schemes as an alternative, that is, K={k₁, . . . , kᵣ, . . . , kₖ}; taking the uncertainty of s attributes S={s₁, . . . s_{q}, . . . , sₛ} (such as pollution degree, restoration target, restoration period, expected cost and acceptable risk) as constraint conditions, giving weights Ws={w₁, . . . w_{q} . . . , wₛ}(w_{q} ∈[0,1], Σ_{q=1}^{s} w_{q}=1) to one or more attributes under different requirements of decision makers, for K and S, generating a decision-making matrix D=(KS_{rq})_{k×s} by a plurality of uncertain forms (such as interval number, interval triangular fuzzy number, interval roughness and cloud model), and screening a plurality of multi-attribute decision-making schemes; inputting the schemes into the decision-making model, introducing a virtual task, controlling a process virtual simulation module by constructing a distribution sequence and in combination with the water environment under the intelligent control scheme, measuring and evaluating the virtual restoration effect by a human-machine synergistic precise group decision-making mode, then screening and sorting the comprehensive priority values of the virtual simulation effects of the k alternative schemes K under different attributes S, finally outputting an optimal control scheme and implementing the optimal control scheme, thereby reducing secondary pollution to the environment; and controlling and monitoring the water environment by the intelligent sensing module, evaluating the actual control effect of the water environment, verifying the feasibility of the scheme, and feeding back and updating the feasibility to the feature knowledge base,

wherein the decision-making matrix D=(KS_{rq})_{k×s}:KS_{rq} refers to the attribute value of the scheme kᵣ about the attribute s_{q}, and the matrix of k×s is formed by k schemes and s attributes.

The data terminal of the processor module is also connected to a visualization module and a storage module respectively; the visualization module introduces a time-space parameter by a BIM technology and a GIS model to establish a three-dimensional model of a monitoring site, such that the environment parameters and geographic features of the actual monitoring site are effectively linked with the model, thereby being capable of intuitively observing changes of data, control schemes and results in the monitoring site water circulation intelligent sensing and monitoring process in time and space dimensions; and the storage module is configured to store constructed feature knowledge graphs, water environment brief reports and water environment control schemes.

Compared with the prior art, the present invention has the following technical effects:

1) the present invention constructing a water circulation intelligent sensing and monitoring system based on differentiable reasoning, which integrates information sensing, collection, acquisition, analysis, reasoning, evaluation, warning, decision making and control. The present acquires multi-source heterogeneous data through multi-source fusion of open databases, Baidu Baike, vertical websites, literatures, research reports and expert experience, and constructs a water circulation feature knowledge base. The feature knowledge base is linked with five modules such as intelligent sensing, intelligent control, display, storage and conversion through a central processing unit, solves the problems that the previous water environment work is based on manual work, complicated to operate, long in time consumption, low in precision and prone to error by using the systematic and intelligent thinking, can evaluate and analyze the water environment state more accurately, can control the sudden pollution events of the water body in real time, can effectively avoid potential water environment risks, and can improve the water environment monitoring and evaluation efficiency.
2) According to the present invention, a differentiable reasoning unit is added, relies on the feature knowledge base, and is bidirectionally linked with the intelligent sensing module and the intelligent control module. An optimal path is searched for the tasks by an efficient and end-to-end differentiable reasoning neural network for progressive reasoning, so that the structured and iterative thinking capability of reasoning can be enhanced, the solution accurate rate can be increased, the reasoning complexity can be reduced, and the complicated reasoning task under various unknown situations. In addition, the complicated problem is iteratively reasoned through differentiable reasoning, so that information is aggregated to fully mine implicit information and improve and complete the knowledge graph.
3) The present invention can achieve water environment monitoring digitization, accurate evaluation, automatic control, intelligent control and management visualization, thereby providing convenient technical support and decision-making means for environment managers and decision makers.

### BRIEF DESCRIPTION OF THE DRAWINGS

The present invention is further described with reference to the accompanying drawings and embodiments:

FIG. 1 is an overall block diagram of a system according to the present invention;

FIG. 2 is a structural diagram of a differentiable recurrent neural network according to the present invention; and

FIG. 3 is a progressive differentiable reasoning architecture diagram according to the present invention.

### DETAILED DESCRIPTION

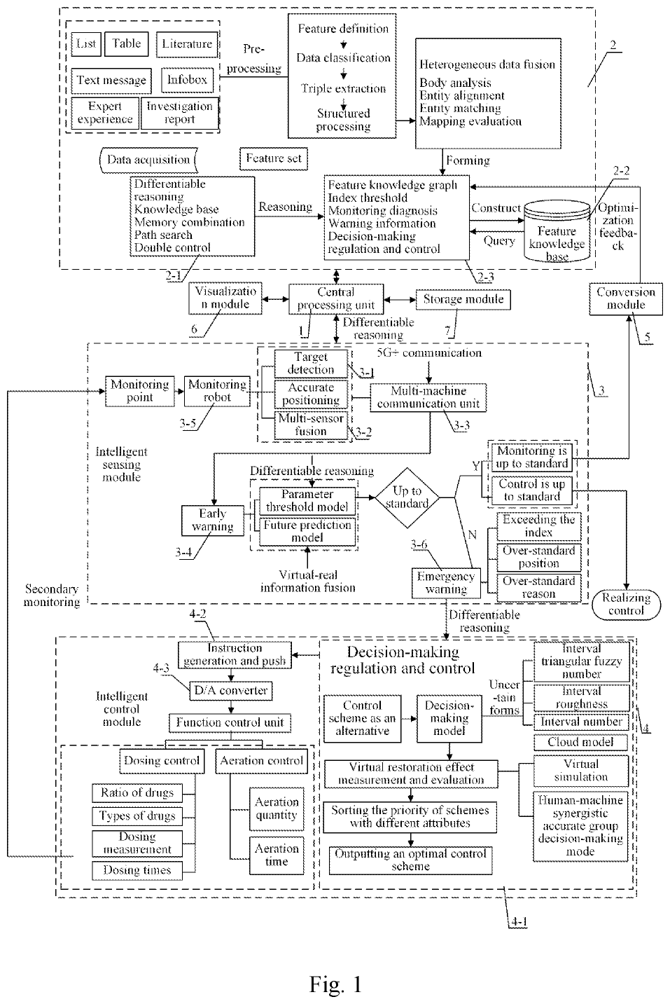

As shown in FIG. 1, a water circulation intelligent sensing and monitoring system based on differentiable reasoning includes a processor module 1, wherein a data terminal of the processor module 1 is connected to a feature knowledge base module 2, an intelligent sensing module 3 and an intelligent control module 4 respectively; the intelligent sensing module 3 is connected to the feature knowledge base module 2 through a conversion module 5;

the feature knowledge base module 2 includes a differentiable reasoning unit 2-1, a feature knowledge base unit 2-2 and a feature knowledge graph unit 2-3; and a data terminal of the feature knowledge graph unit 2-3 is connected to the differentiable reasoning unit 2-1, the feature knowledge base unit 2-2 and the conversion module 5.

The feature knowledge base unit 2-2 includes a collection unit, a construction unit and an application unit.

Specifically, the collection unit crawls various encyclopedic websites, vertical websites, research data and expert experience databases through crawlers or data acquisition software to collect multi-source heterogeneous data, wherein the data specifically includes (a) structured data, (b) semi-structured data and (c) unstructured data.

Specifically, the construction unit performs category classification, extraction and feature definition on the multi-source heterogeneous data collected by the collection unit from various vertical websites, encyclopedic websites and expert knowledge bases to form an event triple (head entity h, relationship/attribute r and tail entity/attribute value t) multi-category feature set, then performs heterogeneous knowledge fusion on the multi-source multi-category feature set and connects a series (h, r and t) relationship paths by supervised random walk to obtain a fusion feature, and finally performs iterative reasoning on complicated problems according to the fusion feature and by differentiable reasoning, constructs a water circulation intelligent sensing and monitoring feature knowledge graph and stores the water circulation intelligent sensing and monitoring feature knowledge graph in the feature knowledge base. In addition, iterative reasoning is performed by differentiable reasoning to select an optimal path to perform iterative reasoning on the complicated problem, and a fusion path is improved, so that information is aggregated to solve the problems of incomplete knowledge graph and insufficient mining of implicit information. The application unit is linked with the intelligent sensing module and the intelligent control module by the differentiable reasoning unit, and performs water environment monitoring diagnosis, early warning or decision-making control services to realize cyclic control, optimization and updating.

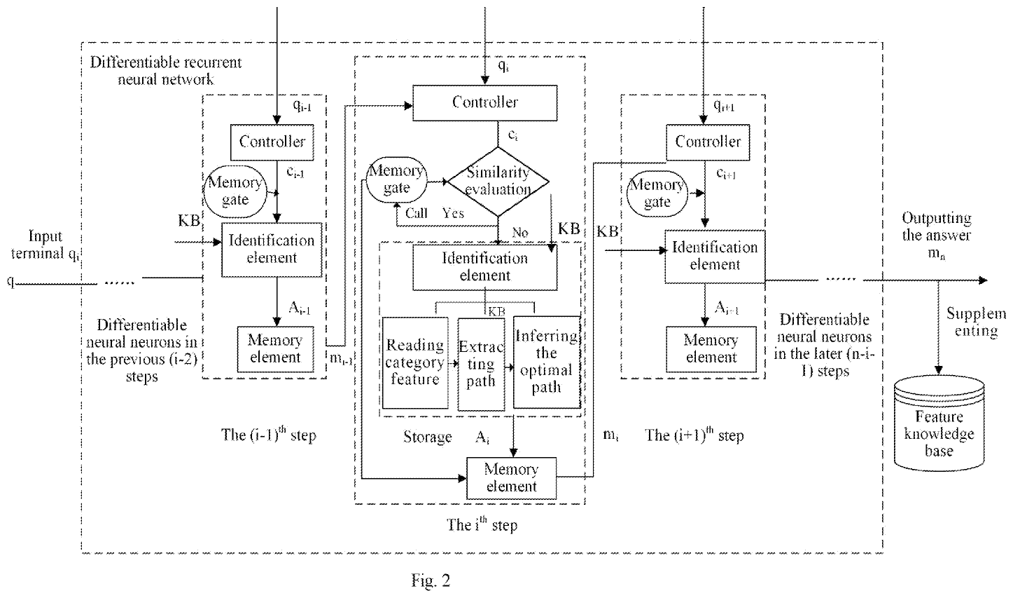

As shown in FIG. 2, differentiable reasoning is to complete a reasoning task in unknown situations by using a differentiable neural network through an input terminal, a differentiable recurrent neural network and an output terminal and supplement and update a knowledge graph. The optimal path of the reasoning task is solved step by step based on the feature knowledge base, thereby realizing end-to-end structured explicit reasoning of the model. The specific implementation steps are as follows:

S₁: a received problem q (such as data index classification, warning information and decision-making schemes) is converted into a distributed vector through input terminal preprocessing to obtain a context character string (cw₁, cw₂, . . . , cwₘ), that is, (h, r₁, r₂, . . . , rₘ₋₂,t) is used to express a fact triple and the problem is represented as q=| [symbol] ₁, [symbol] _{M}|, the context character string is linearly transformed into a position awareness vector qᵢ(i=1, 2, . . . , n), wherein qᵢ∈R^{q} is used to reflect a related problem of the i^{th} reasoning step,

q refers to the received problem, m refers to the length of the character string, (cw₁, cw₂, . . . , cwₘ) refers to the context character string, the problem q is expressed as q=| [symbol] ₁, [symbol] _{M}|, qᵢ(i=1, 2, . . . , n) represents a problem position awareness vector, the definitions of (h, r₁, r₂, . . . , rₘ₋₂,t) are referenced to the description of the embodiments of the present invention, h represents a head entity, r₁, r₂, . . . , rₘ₋₂ represent several relationships/attributes, t represents a tail entity/attribute value, qᵢ∈R^{q} is used to represent a set of the problem position awareness vectors, and the representation mode is a well-known expression mode in the art.

S₂: the reasoning task in the first step is transmitted to a differentiable recurrent neural network, and iterative reasoning is performed for many times. The differentiable recurrent neural network is composed of n differentiable recurrent neurons, each differentiable recurrent neuron participates in a current reasoning task, and each part is composed of a controller, an identification element and a memory element. For a reasoning process in the i^{th} step (i=1, 2, . . . , n), a reasoning task awareness vector qᵢ in the i^{th} step and a memory vector obtained in a memory element in the (i−1)^{th} step is received, and the controller performs processing to obtain a control vector cᵢ=(qᵢ, mᵢ₋₁) and the control vector is transferred to the identification element. The associating global or local knowledge graph path planning with a current reasoning task control vector cᵢ by the identification element based on a given knowledge base, walks in the knowledge graph (KG) based on category feature of cᵢ to extract a representative path (l₁, l₂ . . . lₗ), infers and identifies a matched value P of the control vector cᵢ and the representative path L by a content similarity evaluation function and sorts to finally select an optimal path to obtain a solution vector Aᵢ=(cᵢ, pₘₐₓ). The memory element integrates cᵢ, mᵢ₋₁ and Aᵢ, the integrated value is stored into the memory mᵢ=(cᵢ, mᵢ₋₁, Aᵢ) and transferred to a next reasoning task cᵢ₊₁, the previous steps are iteratively performed to finally obtain an iterative calculation answer through n steps of reasoning processes, wherein a storage structure is arranged in the memory element. An intermediate state in the reasoning process is stored into a memory gate, the intermediate state is inserted into mᵢ₋₁ and the to-be-generated mᵢ in the subsequent reasoning process, the similarity with the previous reasoning task is determined, and if the similarity is high, the reasoning step is skipped, the stored memory state is directly called, the length of the reasoning process is dynamically adjusted and the reasoning times are reduced,

wherein pₘₐₓ refers to the optimal path.

S₃: a final answer is output by an output terminal according to the problem q and the memory result mₙ in the final reasoning process.

Through the self-attention connection between neurons, the differentiable neural network may search a diversified path by a soft method, may adapt to any unknown scenarios and explain the potential reasoning performed therein, and may highlight the end-to-end differentiability, the structure clarity and the reasoning stability, so as to perform model training to solve the single-skipping and multi-skipping problems of a plurality of modules in any scenario, mine the potential information, supplement and update the feature knowledge base, improve the reasoning accuracy and reduce the complexity of the task.

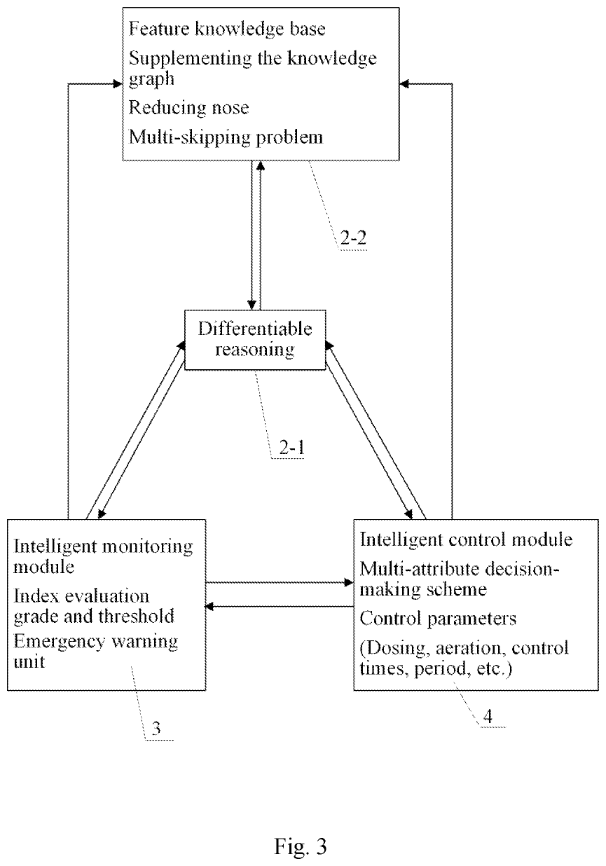

As shown in FIG. 3, a differentiable reasoning unit is bidirectionally linked with the feature knowledge base, the intelligent sensing module and the intelligent control module in pairs, the situation of the water body environment is progressively reasoned step by step to obtain new knowledge, new determination and new decisions, thereby realizing cyclic processing of water environment monitoring, evaluation and control, and realizing virtual-real interaction between static information management of the system and instant dynamic circulation sensing monitoring.

As shown in FIG. 1, the intelligent sensing module includes a target detection unit, a multi-sensor fusion unit, a multi-machine communication unit and an early warning unit. The target detection unit gives instructions such as monitoring a parameter, monitoring a range and acquiring a period to the monitoring robot through a PC terminal or a mobile terminal, so that the monitoring robot performs intelligent sensing on the surrounding environment based on a millimeter wave radar, a laser radar and visible light and infrared modules, so as to acquire environment parameters (including water body physicochemical properties, pollutant concentration and bioactivity) of specified positions in real time; and for the heterogeneous multi-source characteristics of the collected information, multiple-sensor information is fused to improve the environment sensing accuracy and robustness; a real-time monitoring state, environment sensing information, track key position video monitoring information and other data are sent back to an operating terminal by the multi-machine communication unit in real time; and real-time data is processed by an early warning unit threshold model and a prediction model, the situation of the monitoring position is observed by the visualization unit in real time, and the abnormal situation in the water environment monitoring and control process are subjected to prediction calculation and warning prompt, thereby realizing efficient information interconnection therebetween.

Specifically, firstly, during the collection period, the data of monitoring points are collected, including α environmental parameters, and there are H samples for each parameter {αₕⱼ} (j=1, 2, . . . , α; h=1, 2, . . . , H). For each environmental parameter, there are differences in different categories and differences of magnitude, therefore α kinds of environment parameter monitoring data {a₁}, {a₂}, . . . , {aⱼ}, . . . , {aₐ} are standardized and normalized in the acquisition period at a monitoring point to obtain the non-dimensional index value of No.j parameter and No.h sample, aₕⱼ′, and weighting average is used and each environment parameter is processed to obtain the index value of No.j parameter, aⱼ′; secondly, geographic information of a monitoring position is obtained by linking with differentiable reasoning, and considering subjective and objective factors, reasoning is performed to obtain a weight value Wᵥⱼ of each index; finally, a parameter threshold model Vₐ is constructed by using each index value and weight value. In addition, reasoning is performed in the knowledge base by differentiable reasoning to output a water environment evaluation threshold, a grade evaluation set V_{f}′ is established (wherein f is a corresponding grade), normalization and standardization are performed to obtain a combined threshold evaluation value V_{f}. An output value of the parameter threshold model is connected with the combined threshold evaluation value, and the water environment state of the monitoring position is diagnosed. Related formulas are as follows:

$$\{ \begin{matrix}{a}_{hj}^{′} = \vert \frac{max \{ {a}_{h j} \} - {a}_{h j}}{max \{ {a}_{h j} \} - min \{ {a}_{h j} \}} \vert , h ∈ ( 0 , H ) \\ {a}_{j}^{′} = \frac{{Σ}_{j = 1}^{H} {a}_{hj}^{′}}{H} \\ {W}_{v} = \{ {W}_{v 1} , {W}_{v 2} , … , {W}_{v j} , … , {W}_{v a} \} , {W}_{v j} ∈ ( 0 , 1 ) \\ {V}_{a} = \frac{{Σ}_{j = 1}^{a} {W}_{ν j} {a}_{j}^{′}}{a} \\ \begin{matrix}{V}_{f} = \{ {V}_{1} , {V}_{2} , {V}_{3} , {V}_{4} , {V}_{5} \} = \\ \{ excellent , very good , good , poor , very poor \}\end{matrix}\end{matrix} ,$$

f is a grade value

wherein aₕⱼ′ refers to an index value after the h^{th} sample of the j^{th} parameter is treated, aⱼ′ refers to an index value of the j^{th} parameter, and j and h refers to variables in the common sense in the art.

Further, a future prediction model is constructed by an edge calculation gateway to reason and predict the change trend of water environment parameters and diagnose the possible situation according to the combined threshold evaluation value, thereby responding to the sudden pollution events in time, effectively dealing with the events as soon as possible, reducing the pressure of a server and improving the parallel processing efficiency of each module. After the monitoring demonstrates that the water body complies with the standard in the early warning unit, the standard-complying information is updated to the feature knowledge base unit through the conversion module; and if the monitoring demonstrates that the water body does not comply with the standard, the emergency warning unit gives a warning to the operating terminal in time.

In addition, the early warning unit is linked with the visualization module and maps the actual situation on the PC terminal or mobile terminal to realize “physical world-information world” bidirectional information communication and fusion, and can intuitively master the actual situation and make timely and effective decisions.

As shown in FIG. 1, the intelligent control module includes a decision-making regulation and control unit, an instruction generation and push unit, a D/A converter and a function control unit. The intelligent control module is configured to treat a water body that does not comply with a standard, thereby making the water environment comply with the standard.

Specifically, the decision-making regulation and control unit performs efficient simulation reasoning exercise on a complicated actual water body environment through differentiable reasoning in the feature knowledge base module through the central processing unit according to the warning information, performs iterative solution and continuously adjusts an existing strategy to match and generate a high-quality verifiable control scheme as an alternative, and screens an optimal control scheme according to different types of multi-attribute decision-makings to solve the problems. Specific steps are as follows:

specifically, the decision-making regulation and control unit takes to-be-solved problems as input variables X based on the complicated actual water body environment according to the warning information, wherein the problems should specifically include time-space information of monitoring points, over-standard parameters and over-standard index values; differentiable reasoning iterative calculation is performed to match in the feature knowledge base and generate k control schemes as an alternative, that is, K={k₁, . . . , kᵣ, . . . , kₖ}; the uncertainty of s attributes S={s₁, . . . s_{q}, . . . , sₛ} (such as pollution degree, restoration target, restoration period, expected cost and acceptable risk) is taken as constraint conditions, weights Ws={w₁, . . . w_{q} . . . , wₛ} (w_{q} ∈[0,1], Σ_{q=1}^{s} w_{q}=1) are given to one or more attributes under different requirements of decision makers, for K and S, a decision-making matrix D=(KS_{rq})_{k×s} is generated by a plurality of uncertain forms (such as interval number, interval triangular fuzzy number, interval roughness and cloud model), and a plurality of multi-attribute decision-making schemes are screened; the schemes are input into the decision-making model, a virtual task is introduced, a process virtual simulation module is controlled by constructing a distribution sequence and in combination with the water environment under the intelligent control scheme, the virtual restoration effect is measured and evaluated by a human-machine synergistic precise group decision-making mode, in this case, the comprehensive priority values of the virtual simulation effects of the k alternative schemes K are screened and sorted under different attributes S, finally an optimal control scheme is output and implemented, thereby reducing secondary pollution to the environment. The water environment is controlled and monitored by the intelligent sensing module, the actual control effect of the water environment is evaluated, and the feasibility of the scheme is verified and is fed back and updated to the feature knowledge base,

wherein the decision-making matrix D=(KS_{rq})_{k×s}:KS_{rq} refers to the attribute value of the scheme kᵣ about the attribute s_{q}, and the matrix of k×s is formed by k schemes and s attributes.

Specifically, the instruction generation and push unit is configured to transmit the generated control scheme through the central processing unit for processing; the D/A converter is configured to change the control scheme into a voltage or current signal and transmits the voltage or current signal to the function control unit for implementation; the function control unit is configured to implement the control scheme, including dosing control and aeration control; and the function control unit adopts a switching controller based on feedback linearization and time scaling control to improve the control stability and realize efficient operation of work. The dosing control can maximally exert the effect of drugs by setting the ratio of the drugs, the types of the drugs, the dosage, the dosing times and other parameters, and avoid untimely treatment or secondary pollution. The aeration control is balance and stabilize aeration distribution by adjusting the aeration quantity and the aeration time, thereby improving the control precision and treatment efficiency and saving cost and energy consumption.

Specifically, the conversion module is configured to convert the data acquisition information, risk evaluation situation and intelligent control result into structured data, store the structured data into the constructed feature knowledge graph and automatically update the constructed feature knowledge graph.

The visualization module includes a PC terminal or mobile terminal, introduces a time-space parameter by a BIM technology and a GIS model to establish a three-dimensional model of a monitoring site, such that the environment parameters and geographic features of the actual monitoring site are effectively linked with the model, thereby being capable of intuitively observing changes of data, control schemes and results in the monitoring site water circulation intelligent sensing and monitoring process in time and space dimensions.

Specifically, the storage module is configured to store feature knowledge graphs, water environment brief reports and water environment control schemes.

Specifically, a water circulation intelligent sensing and monitoring system based on differentiable reasoning is implemented by the following steps:

Step 1: a progressive differentiable reasoning unit 2-1 is built, and a feature knowledge graph 2-3 based on differentiable reasoning is constructed and stored in a feature knowledge base 2-2.

Step 2: monitoring parameter information is set in the intelligent sensing module 3, and the monitoring point is subjected to data acquisition, processing and transmission according to the designed process flow. After this process is completed, the early warning unit 3-4 diagnoses the up-to-standard situation of data at the monitoring point based on the differentiable reasoning unit 2-1; if the data is qualified, the data is stored in the feature knowledge base 2-2 through a conversion module 5; and if the data is unqualified, the data is transmitted to an intelligent control module 4 for control, and the geographic and environment information of the monitoring point is positioned accurately in combination with an emergency warning unit 3-6 and a visualization module 6 and is fed back timely and effectively.

Step 3: in the intelligent control module 4, a decision-making model is adjusted based on different requirements of decision makers; and based on the above information, the complicated actual water body environment is subjected to efficient simulation reasoning exercise in the feature knowledge base module 2 through the differentiable reasoning unit 2-1 and in combination with a virtual simulation module, and an optimal control scheme is screened. After this process is completed, the control scheme is implemented by an instruction generation and push unit 4-2, a D/A converter 4-3 and a switching controller.

Step 4: after the process flow of the control scheme is completed, a new water circulation intelligent sensing and intelligent control process flow is performed, the step 2 is repeated, and secondary monitoring is performed in the original parameter setting situation; if the water body is controlled to comply with a standard, the standard-complying information is updated to the feature knowledge base through the conversion module 5; and if the water body is controlled not to comply with the standard, the step 3 is repeated until control is realized, and the process ends.

What is claimed is:

1. A water circulation intelligent sensing and monitoring system based on differentiable reasoning, comprising a processor module (1), wherein a data terminal of the processor module (1) is connected to a feature knowledge base module (2), an intelligent sensing module (3) and an intelligent control module (4) respectively; the intelligent sensing module (3) is connected to the feature knowledge base module (2) through a conversion module (5);
the feature knowledge base module (2) comprises a differentiable reasoning unit (2-1), a feature knowledge base unit (2-2) and a feature knowledge graph unit (2-3); and a data terminal of the feature knowledge graph unit (2-3) is connected to the differentiable reasoning unit (2-1), the feature knowledge base unit (2-2) and the conversion module (5).

2. The system according to claim 1, wherein the feature knowledge base unit (2-2) comprises a collection unit, a construction unit and an application unit, wherein,
the collection unit collects multi-source heterogeneous data;
the construction unit performs category classification, extraction and feature definition on the collected multi-source heterogeneous data to form a multi-category feature set, then performs heterogeneous knowledge fusion on the multi-source multi-category feature set and acquires a fusion feature by supervised random walk, and performs iterative reasoning on complicated problems according to the fusion feature and by differentiable reasoning, constructs a water circulation intelligent sensing and monitoring feature knowledge graph and stores the water circulation intelligent sensing and monitoring feature knowledge graph in a feature knowledge base; and
the application unit is linked with the intelligent sensing module (3) and the intelligent control module (4) by the differentiable reasoning unit (2-1), and performs water environment monitoring diagnosis, early warning or decision-making control services to realize cyclic control, optimization and updating.

3. The system according to claim 1, wherein when the differentiable reasoning unit (2-1) is configured to update the feature knowledge graph unit (2-3) and handle the complicated problems of the application unit, the following steps are adopted:
S₁: converting a received problem q into a distributed vector through input terminal preprocessing to obtain a context character string (cw₁, cw₂, . . . , cwₘ), wherein (h, r₁, r₂, . . . , rₘ₋₂,t) is used to express a fact triple and the problem is represented as q=| [symbol] ₁, [symbol] _{M}|, the context character string is linearly transformed into a position awareness vector qᵢ(i=1, 2, . . . , n), and qᵢ∈R^{q} is used to reflect a related problem of the i^{th} reasoning step,
and wherein q refers to the received problem, m refers to the length of the character string, (cw₁, cw₂, . . . , cwₘ) refers to the context character string, the problem q is expressed as q=| [symbol] ₁, [symbol] _{M}|, qᵢ(i=1, 2, . . . , n) represents a problem position awareness vector, h represents a head entity, r₁, r₂, . . . , rₘ₋₂ represent several relationships/attributes, t represents a tail entity/attribute value, and qᵢ∈R^{q} is used to represent a set of the problem position awareness vectors;
S₂: transmitting a reasoning task in the first step to a differentiable recurrent neural network, beginning to perform iterative reasoning for many times, wherein the differentiable recurrent neural network is composed of n differentiable recurrent neurons, each differentiable recurrent neuron participates in a current reasoning task, and each part is composed of a controller, an identification element and a memory element; for a reasoning process in the i^{th} step (i=1, 2, . . . , n), receiving a reasoning task awareness vector qᵢ in the i^{th} step and a memory vector mᵢ₋₁ obtained in a memory element in the (i−1)^{th} step, processing by the controller to obtain a control vector cᵢ=(qᵢ,mᵢ₋₁) and transferring the control vector to the identification element, associating global or local knowledge graph path planning with a current reasoning task control vector cᵢ by the identification element based on a given knowledge base, performing walking on the knowledge graph (KG) based on category feature of cᵢ to extract a representative path L(l₁, l₂ . . . lₗ), inferring and identifying a matched value P of the control vector cᵢ and the representative path L by a content similarity evaluation function and performing sorting to select an optimal path to obtain a solution vector Aᵢ=(cᵢ,pₘₐₓ), integrating cᵢ, mᵢ₋₁ and Aᵢ by the memory element, storing an integrated value into the memory mᵢ=(cᵢ, mᵢ₋₁, Aᵢ) and transferring to a next reasoning task cᵢ₊₁, iteratively performing the previous steps to obtain an iterative calculation answer through n steps of reasoning processes, wherein a storage structure is arranged in the memory element; storing an intermediate state in the reasoning process into a memory gate, inserting the intermediate state into and the to-be-generated mᵢ in the subsequent reasoning process, determining the similarity with the previous reasoning task, and if the similarity is high, skipping the reasoning step, directly calling the stored memory state, dynamically adjusting the length of the reasoning process and reducing the reasoning times,
wherein pₘₐₓ refers to the optimal path; and
S₃: outputting a final answer by an output terminal according to the problem q and the memory result mₙ in the final reasoning process.

4. The system according to claim 1, wherein a data terminal of the differentiable reasoning unit (2-1) is bidirectionally linked with the feature knowledge base unit (2-2), the intelligent sensing module (3) and the intelligent control module (4) respectively in pairs; an output terminal of the intelligent sensing module (3) is connected to an input terminal of the feature knowledge base unit (2-2); an output terminal of the intelligent control module (4) is connected to the input terminal of the feature knowledge base unit (2-2); the intelligent sensing module (3) and the intelligent control module (4) are bidirectionally linked; and the intelligent control module (4) is configured to treat a water body that does not comply with a standard, thereby making the water environment comply with the standard.

5. The system according to claim 1, wherein the intelligent sensing module (3) comprises a target detection unit (3-1), a multi-sensor fusion unit (3-2), a multi-machine communication unit (3-3) and an early warning unit (3-4); input terminals of the target detection unit (3-1) and the multi-sensor fusion unit (3-2) are configured to be connected to a monitoring robot (3-5), and output terminals of the target detection unit (3-1) and the multi-sensor fusion unit (3-2) are connected to an input terminal of the multi-machine communication unit (3-3); and an output terminal of the multi-machine communication unit (3-3) is connected to an output terminal of the early warning unit (3-4).

6. The system according to claim 5, wherein the target detection unit (3-1) gives instructions such as monitoring a parameter, monitoring a range and acquiring a period to the monitoring robot (3-5) through a PC terminal or a mobile terminal, so that the monitoring robot (3-5) performs intelligent sensing on the surrounding environment based on a millimeter wave radar, a laser radar and visible light and infrared modules, so as to acquire environment parameters of specified positions in real time; and for the heterogeneous multi-source characteristics of the acquired information, multiple-sensor information is fused to improve the environment sensing accuracy and robustness; a real-time monitoring state, environment sensing information, track key position video monitoring information and other data are sent back to an operating terminal by the multi-machine communication unit (3-3) in real time; and real-time data is processed by the early warning unit (3-4).

7. The system according to claim 5, wherein when the water environment of the monitoring position is diagnosed by the intelligent sensing module (3), the following steps are adopted:
firstly, standardizing and normalizing a kinds of environment parameter monitoring data {a₂}, {a₂}, . . . , {aⱼ}, . . . , {aₐ} in the acquisition period at a monitoring point to obtain aₕⱼ′, and using weighting average and processing each environment parameter to obtain aⱼ′; secondly, linking with differentiable reasoning to obtain geographic information of a monitoring position, and considering subjective and objective factors and performing reasoning to obtain a weight value Wᵥⱼ of each index; finally, constructing a parameter threshold model Vₐ by using each index value and weight value, in addition, performing reasoning in the knowledge base by differentiable reasoning to output a water environment evaluation threshold, establishing a grade evaluation set V_{f}′ (wherein f is a corresponding grade), performing normalization and standardization to obtain a combined threshold evaluation value V_{f}, connecting an output value of the parameter threshold model with the combined threshold evaluation value, and diagnosing the water environment state of the monitoring position, wherein related formulas are as follows:
$$\{ \begin{matrix}{a}_{hj}^{′} = \vert \frac{max \{ {a}_{h j} \} - {a}_{h j}}{max \{ {a}_{h j} \} - min \{ {a}_{h j} \}} \vert , h ∈ ( 0 , H ) \\ {a}_{j}^{′} = \frac{{Σ}_{j = 1}^{H} {a}_{hj}^{′}}{H} \\ {W}_{v} = \{ {W}_{v 1} , {W}_{v 2} , … , {W}_{v j} , … , {W}_{v a} \} , {W}_{v j} ∈ ( 0 , 1 ) \\ {V}_{a} = \frac{{Σ}_{j = 1}^{a} {W}_{ν j} {a}_{j}^{′}}{a} \\ \begin{matrix}{V}_{f} = \{ {V}_{1} , {V}_{2} , {V}_{3} , {V}_{4} , {V}_{5} \} = \\ \{ excellent , very good , good , poor , very poor \}\end{matrix}\end{matrix} ,$$
f is a grade value,
wherein aₕⱼ′ refers to an index value after the h^{th} sample of the j^{th} parameter is treated, aⱼ′ refers to an index value of the j^{th} parameter, and j refers to j^{th} environment parameter and h refers to h^{th} sample of each environment parameter.

8. The system according to claim 1, wherein the intelligent control module (4) comprises a decision-making regulation and control unit (4-1), and an instruction generation and push unit (4-2) connected to an output terminal of the decision-making regulation and control unit (4-1); an output terminal of the instruction generation and push unit (4-2) is connected to an input terminal of a D/A converter (4-3); an output terminal of the D/A converter (4-3) is connected to an input terminal of a function control unit; and the function control unit is configured to implement a control scheme, including dosing control and aeration control.

9. The system according to claim 8, wherein after the monitoring demonstrates that the water body complies with the standard in the early warning unit (3-4) in the intelligent sensing module (3), standard-complying information is updated to the feature knowledge base unit (2-2) through the conversion module (5); if the monitoring demonstrates that the water body does not comply with the standard, an emergency warning unit (3-6) sends a warning signal timely, and the decision-making regulation and control unit (4-1) performs efficient simulation reasoning exercise on a complicated actual water body environment through the differentiable reasoning unit (2-1) in the feature knowledge base module (2) through the processor module (1) according to the warning information, performs iterative solution and continuously adjusts an existing strategy to match and generate a high-quality verifiable control scheme as an alternative, and screens an optimal control scheme according to different types of multi-attribute decision-makings to solve the problems;
the specific steps are as follows:
taking, by the decision-making regulation and control unit, to-be-solved problems as input variables X based on the complicated actual water body environment according to the warning information, wherein the problems should specifically comprise time-space information of monitoring points, over-standard parameters and over-standard index values; performing differentiable reasoning iterative calculation to match in the feature knowledge base and generate k control schemes as alternatives, that is, K={k₁, . . . , kᵣ, . . . , kₖ}; taking the uncertainty of s attributes S={s₁, . . . s_{q}, . . . , sₛ} (such as pollution degree, restoration target, restoration period, expected cost and acceptable risk) as constraint conditions, giving weights Ws={w₁, . . . w_{q} . . . wₛ}(w_{q} ∈[0,1], Σ_{q=1}^{s} w_{q}=1) to one or more attributes under different requirements of decision makers, for K and S, generating a decision-making matrix D=(KS_{rq})_{k×s} by a plurality of uncertain forms (such as interval number, interval triangular fuzzy number, interval roughness and cloud model), and screening a plurality of multi-attribute decision-making schemes; inputting the schemes into the decision-making model, introducing a virtual task, controlling a process virtual simulation module by constructing a distribution sequence and in combination with the water environment under the intelligent control scheme, measuring and evaluating the virtual restoration effect by a human-machine synergistic precise group decision-making mode, then screening and sorting the comprehensive priority values of the virtual simulation effects of the k alternative schemes K under different attributes S, and finally outputting an optimal control scheme and implementing the optimal control scheme, thereby reducing secondary pollution to the environment; and controlling and monitoring the water environment by the intelligent sensing module, evaluating the actual control effect of the water environment, verifying the feasibility of the scheme, and feeding back and updating the feasibility to the feature knowledge base,
wherein the decision-making matrix D=(KS_{rq})_{k×s}:KS_{rq} refers to the attribute value of the scheme kᵣ about the attribute s_{q}, and the matrix of k×s is formed by k schemes and s attributes.

10. The system according to claim 1, wherein the data terminal of the processor module (1) is further connected to a visualization module (6) and a storage module (7), respectively; the visualization module (6) introduces a time-space parameter by a BIM technology and a GIS model to establish a three-dimensional model of a monitoring site, such that the environment parameters and geographic features of the actual monitoring site are effectively linked with the model, thereby being capable of intuitively observing changes of data, control schemes and results in the monitoring site water circulation intelligent sensing and monitoring process in time and space dimensions; and the storage module (7) is configured to store constructed feature knowledge graphs, water environment brief reports and water environment control schemes.

11. The system according to claim 2, wherein the intelligent sensing module (3) comprises a target detection unit (3-1), a multi-sensor fusion unit (3-2), a multi-machine communication unit (3-3) and an early warning unit (3-4); input terminals of the target detection unit (3-1) and the multi-sensor fusion unit (3-2) are configured to be connected to a monitoring robot (3-5), and output terminals of the target detection unit (3-1) and the multi-sensor fusion unit (3-2) are connected to an input terminal of the multi-machine communication unit (3-3); and an output terminal of the multi-machine communication unit (3-3) is connected to an output terminal of the early warning unit (3-4).

12. The system according to claim 3, wherein the intelligent sensing module (3) comprises a target detection unit (3-1), a multi-sensor fusion unit (3-2), a multi-machine communication unit (3-3) and an early warning unit (3-4); input terminals of the target detection unit (3-1) and the multi-sensor fusion unit (3-2) are configured to be connected to a monitoring robot (3-5), and output terminals of the target detection unit (3-1) and the multi-sensor fusion unit (3-2) are connected to an input terminal of the multi-machine communication unit (3-3); and an output terminal of the multi-machine communication unit (3-3) is connected to an output terminal of the early warning unit (3-4).

13. The system according to claim 4, wherein the intelligent sensing module (3) comprises a target detection unit (3-1), a multi-sensor fusion unit (3-2), a multi-machine communication unit (3-3) and an early warning unit (3-4); input terminals of the target detection unit (3-1) and the multi-sensor fusion unit (3-2) are configured to be connected to a monitoring robot (3-5), and output terminals of the target detection unit (3-1) and the multi-sensor fusion unit (3-2) are connected to an input terminal of the multi-machine communication unit (3-3); and an output terminal of the multi-machine communication unit (3-3) is connected to an output terminal of the early warning unit (3-4).

14. The system according to claim 11, wherein the target detection unit (3-1) gives instructions such as monitoring a parameter, monitoring a range and acquiring a period to the monitoring robot (3-5) through a PC terminal or a mobile terminal, so that the monitoring robot (3-5) performs intelligent sensing on the surrounding environment based on a millimeter wave radar, a laser radar and visible light and infrared modules, so as to acquire environment parameters of specified positions in real time; and for the heterogeneous multi-source characteristics of the acquired information, multiple-sensor information is fused to improve the environment sensing accuracy and robustness; a real-time monitoring state, environment sensing information, track key position video monitoring information and other data are sent back to an operating terminal by the multi-machine communication unit (3-3) in real time; and real-time data is processed by the early warning unit (3-4).

15. The system according to claim 12, wherein the target detection unit (3-1) gives instructions such as monitoring a parameter, monitoring a range and acquiring a period to the monitoring robot (3-5) through a PC terminal or a mobile terminal, so that the monitoring robot (3-5) performs intelligent sensing on the surrounding environment based on a millimeter wave radar, a laser radar and visible light and infrared modules, so as to acquire environment parameters of specified positions in real time; and for the heterogeneous multi-source characteristics of the acquired information, multiple-sensor information is fused to improve the environment sensing accuracy and robustness; a real-time monitoring state, environment sensing information, track key position video monitoring information and other data are sent back to an operating terminal by the multi-machine communication unit (3-3) in real time; and real-time data is processed by the early warning unit (3-4).

16. The system according to claim 13, wherein the target detection unit (3-1) gives instructions such as monitoring a parameter, monitoring a range and acquiring a period to the monitoring robot (3-5) through a PC terminal or a mobile terminal, so that the monitoring robot (3-5) performs intelligent sensing on the surrounding environment based on a millimeter wave radar, a laser radar and visible light and infrared modules, so as to acquire environment parameters of specified positions in real time; and for the heterogeneous multi-source characteristics of the acquired information, multiple-sensor information is fused to improve the environment sensing accuracy and robustness; a real-time monitoring state, environment sensing information, track key position video monitoring information and other data are sent back to an operating terminal by the multi-machine communication unit (3-3) in real time; and real-time data is processed by the early warning unit (3-4).

17. The system according to claim 2, wherein the intelligent control module (4) comprises a decision-making regulation and control unit (4-1), and an instruction generation and push unit (4-2) connected to an output terminal of the decision-making regulation and control unit (4-1); an output terminal of the instruction generation and push unit (4-2) is connected to an input terminal of a D/A converter (4-3); an output terminal of the D/A converter (4-3) is connected to an input terminal of a function control unit; and the function control unit is configured to implement a control scheme, including dosing control and aeration control.

18. The system according to claim 3, wherein the intelligent control module (4) comprises a decision-making regulation and control unit (4-1), and an instruction generation and push unit (4-2) connected to an output terminal of the decision-making regulation and control unit (4-1); an output terminal of the instruction generation and push unit (4-2) is connected to an input terminal of a D/A converter (4-3); an output terminal of the D/A converter (4-3) is connected to an input terminal of a function control unit; and the function control unit is configured to implement a control scheme, including dosing control and aeration control.

19. The system according to claim 4, wherein the intelligent control module (4) comprises a decision-making regulation and control unit (4-1), and an instruction generation and push unit (4-2) connected to an output terminal of the decision-making regulation and control unit (4-1); an output terminal of the instruction generation and push unit (4-2) is connected to an input terminal of a D/A converter (4-3); an output terminal of the D/A converter (4-3) is connected to an input terminal of a function control unit; and the function control unit is configured to implement a control scheme, including dosing control and aeration control.
